(19) United States
(12) Patent Application Publication
(10) Pub. No.: US 2017/0291385 A1
(43) Pub. Date: Oct. 12, 2017

(54) Concrete Curing Blanket

(71) Applicants: Michael E. Carroll, Loganville, GA (US); Richard D. Jordan, Lawrenceville, GA (US); Ronald C. Norris, Hoschton, GA (US)

(72) Inventors: Michael E. Carroll, Loganville, GA (US); Richard D. Jordan, Lawrenceville, GA (US); Ronald C. Norris, Hoschton, GA (US)

(21) Appl. No.: 15/098,172

(22) Filed: Apr. 13, 2016

Related U.S. Application Data
(60) Provisional application No. 62/146,788, filed on Apr. 13, 2015.

(51) Int. Cl. B32B 5/02; B32B 27/28; B32B 27/06; E04G 21/24; B32B 17/02

(52) U.S. Cl. CPC B32B 5/02; E04G 21/246; B32B 17/02; B32B 27/06; B32B 27/28; B32B 2307/728; B32B 2307/73

(57) ABSTRACT

Disclosed is a concrete curing blanket including a film layer, a differential hydrophobic/hydrophillic layer and a gel layer interposed therebetween.

### REFERENCE TO EARLIER APPLICATION

This Application incorporates by reference and, under 35 U.S.C. §119(e), claims priority to U.S. Provisional Patent Application Ser. No. 62/146788 filed on Apr. 13, 2015.

### STATEMENT REGARDING FEDERALLY SPONSORED RESEARCH OR DEVELOPMENT

This invention is not the subject of federally sponsored research or development.

### RESERVATION OF COPYRIGHTS

Portions of the disclosure of this document contain material that is subject to copyright protection. The copyright owner has no objection to any reproduction of the document or disclosure as it appears in official records, but reserves all remaining rights under copyright.

### BACKGROUND OF THE INVENTION

Concrete is a widely used construction material. In general, concrete is composed of cement, coarse and fine aggregates and chemical additives. “Concrete” describes a mixture of stone, gravel or brushed rock and sand, referred to as “aggregate,” which is bound by a cement. As used herein, “concrete” includes reinforced concrete, concrete that contains organic or silica-based fibers or metallic wire, cable or rods as a reinforcing substance, and polymer-cement concrete that is bound with Portland cement and a polymerized monomer or resin system. Hydraulic concrete and cement are referred to herein as “concrete.” Additional information on the composition and characteristics of concrete may be found in Basic Construction Materials by C. A. Herubin and T. W. Narotta, third edition, Reston Book, Englewood, N.J., which is incorporated herein by reference.

The most common hydraulic cement for construction purposes is Portland cement. Portland cement is a heat-treated mixture primarily of calcium carbonate-rich material, such as limestone, marl or chalk, and material that is rich in Al₂SiO₂, such as clay or shale. Portland cement comes in several varieties that are distinguished by such characteristics as the rate of acquiring strength during curing, the amount of heat of hydration generated, and resistance to sulfate attack. Other types of hydraulic cements include aluminous cement, chalcedony cement, which is made from amorphous quartz, and Roman cement, which combines burnt clay or volcanic ash with lime and sand.

Concrete is mixed with water to form a thick slurry, poured into place, typically within forms that contain expansion of the slurry, finished and then cured. Curing involves chemical changes that result in setting and hardening. These chemical changes occur over a considerable period of time in the presence of water. The water mixed in with the original slurry is insufficient for curing.

Adding water, i.e. hydration, is important in the curing of hydraulic concretes, concretes that are dependent on a hydration reaction for hardening, and concretes that are bound with hydraulic concretes. According to ACI 301, hydration should be kept at or above 80% throughout the curing cycle to reduce shrinkage. Ideally, concrete should be kept wet after it has set for as long a period as is practicable. This period generally ranges from 7 to 21 days.

Producing quality hydraulic concrete or cement requires proper curing. Curing increases concrete strength, hence structural value. Proper curing is necessary for producing water-tight, durable concrete.

Concrete strength and water-resistance improves when the cement is thoroughly hydrated during curing. Proper curing slows the loss of moisture from concrete and reduces early carbonation of the surface. Excessive evaporation and drying or otherwise poor curing of concrete inhibits hydration. If drying is excessive, light traffic on a concrete surface may result in dusting. Inadequate curing also may cause “craze cracking” or “crazing.”

A concrete floor dusts under traffic because the wearing surface is weak. This weakness can be caused by the finishing operation performed over bleed water on the surface. Finishing or working this bleed water back into the top of the slab produces a low strength layer right at the surface. Placement of concrete over poly or some non absorbent surface, increases bleeding and as a result the risk of surface dusting.

“Crazing” or “map cracking” is a pattern of random fine cracks that occur at the surface of concrete at an early age when the unhardened surface mortar dries out faster than the concrete below. This drying at the surface causes the concrete at the surface to shrink at a faster rate than the concrete below causing stresses at the surface resulting in the fine “map crack” pattern. Since these cracks occur at the surface only, they become an unpleasant sight but are none-the-less harmless structurally and will not cause durability problems. Crazing may be more evident when slabs are constructed in hot, windy, and dry installation conditions.

Maintaining an optimal amount of water in contact with curing concrete optimizes the strength and durability of the concrete. For example, if concrete is kept wet for the first ten days after setting, strength and durability thereof increase 75 percent over ordinary aging at dry surface conditions. As reported by Ken Hover in Curing and Hydration: Two Half Truths Don't Make a Whole, published in the summer 2002 edition of the Concrete News by L & M Construction Chronicles, the more water that is made available to the concrete during curing, the better.

To keep concrete hydrated, the concrete industry has come to rely on concrete curing blankets for covering wetted concrete and extending the duration of damp conditions on the curing surface thereof. Some concrete curing blankets have included burlap and cotton mats, wet rugs, moist earth or sand, sawdust and other coverings likely to act as a moisture barrier. Burlap-based blankets pose many problems, including hydrophillic greasiness; large voids that promote non-uniform concrete surface wetting; stiffness and non-resiliency that prevents conformity to surface irregularities; and fibers that snag on concrete surfaces, which may lead to undesired markings. Cotton mats tend to disintegrate well before the desired curing duration, leaving clumps of material stuck on the surface requiring refinishing. Some concrete curing blankets also have included moisture barriers, such as water-proof papers and plastic films. While films may help reduce evaporation, they do not cure problems associated with the water availability underlying the absorbent layer or free space. An ideal curing blanket would have a vapor barrier and a constant supply of curing water as a layer between the vapor barrier and concrete surface.

A common problem with slopped and or vertical concrete curing applications is that curing blankets do not have sufficient absorptive strength to retain water subjected to gravitational influence, wherein water that was originally placed in the blanket and available for curing drains away from the curing concrete in a short time, requiring frequent or constant monitoring and rewetting as needed to develop intended concrete properties.

As used herein, “superabsorbents” refers, but is not limited to superabsorbent polymers and can take the form of gels, resins, powders and/or fibers.

As used herein, “superabsorbent polymers” (“SAP”) refers to polymers that can absorb and retain extremely large amounts of a liquid relative to their own mass. Water absorbing SAP, classified as hydrogels, when cross-linked, absorb aqueous solutions through hydrogen bonding with water molecules. A SAP's ability to absorb water is a factor of the ionic concentration of the aqueous solution. In deionized and distilled water, a SAP may absorb 500 times its weight (from 30-60 times its own volume) and can become up to 99.9% liquid, but when put into a 0.9% saline solution, the absorbency drops to maybe 50 times its weight.

The total absorbency and swelling capacity are controlled by the type and degree of cross-linkers used to make the gel. Low density cross-linked SAP generally have a higher absorbent capacity and swell to a larger degree. These types of SAPs also have a softer and more sticky gel formation. High cross-link density polymers exhibit lower absorbent capacity and swell, but the gel strength is firmer and can maintain particle shape even under modest pressure.

SAPs commonly are made from the polymerization of acrylic acid blended with sodium hydroxide in the presence of an initiator to form a poly-acrylic acid sodium salt, sometimes referred to as sodium polyacrylate. Other materials also used to make SAPs include, but are not limited to: polyacrylamide copolymer, ethylene maleic anhydride copolymer, cross-linked carboxymethylcellulose, polyvinyl alcohol copolymers, cross-linked polyethylene oxide, and starch grafted copolymer of polyacrylonitrile.

As used herein, “superabsorbent fibers” (“SAF”) are white, odorless and have the appearance and improved handling characteristics of textile fibers, while offering the possibility of being used to produce a wide range of fabrics. SAF are made from crosslinked polymerization of sodium acrylate, acrylic acid and methyl acrylate. SAF provide extremely high rates of saline and water uptake. SAF also add strength as a fibril element rather than a particle.

As used herein, “crepeing” refers, but is not limited to a process commonly used in the paper industry involving buckling and/or folding, as is commonly used in the manufacture of paper towels and the like.

As used herein, “binder materials” refers, but is not limited to bicomponent fibers, liquid latex, any glue that increases hydrogen bonding.

As used herein, “OCC” refers to “old corrugated containers,” but is not limited to non-bleached, recycled corrugated boxes having outer layers separated by an inner, serpentine component. OCC does not leach tannins like burlap. The inner component typically is made from hardwood in a pulp digester, thus commonly referred to as “half cooked.” The inner component typically has low strength, but is of high output. The outer layers are made of liner board and typically have more lignen fibers, thus more strength and stiffness. It is these properties of the outer layer materials that are retained in OCC that provide for wicking and maintaining loft or caliper for maximum water retention while reducing the chances of the blanket collapsing on itself from the weight of the water.

As used herein, absorptive/hydrophilic fibers refers, but is not limited to OCC fibers and could include any other economically desirable fiber, like rayon.

While effective for their intended purposes, thermally- and latex-bonded curing blankets are costly to manufacture from equipment and materials perspectives. Latex-bonded materials also may not be hydrophobic, which would lead to blanket layer breakdown well before the prescribed duration for curing concrete.

What is needed is a durable concrete curing blanket that promotes distribution of available water over a curing concrete surface, particularly a sloped or vertical surface, and discourages evaporation.

The invention provides improved elements and arrangements thereof, for the purposes described, which are inexpensive, dependable and effective in accomplishing intended purposes of the invention.

Other features and advantages of the invention will become apparent from the following description of the preferred embodiments.

### BRIEF DESCRIPTION OF THE DRAWINGS

The invention is described in detail below with reference to the following figures s, throughout which similar reference characters denote corresponding features consistently, wherein:

FIG. 1 is a schematic representation of an embodiment of a concrete curing blanket configured according to principles of the invention; and

FIGS. 2-6 are cross-sectional detail views of other embodiments of a concrete curing blanket configured according to principles of the invention.

### DETAILED DESCRIPTION OF THE PREFERRED EMBODIMENTS

This disclosure is not limited in application to the details of construction and the arrangement of components set forth herein. The disclosure is capable of other embodiments and of being practiced or of being carried out in various ways. Phraseology and terminology used herein is for description and should not be regarded as limiting. Uses of “including,” “comprising” or “having” and variations thereof herein are meant to encompass the items listed thereafter and equivalents thereof as well as additional items. Unless limited otherwise, “connected,” “coupled” and “mounted,” and variations thereof herein are used broadly and encompass direct and indirect connections, couplings, and mountings. “Connected” and “coupled” and variations thereof are not restricted to physical or mechanical or electrical connections or couplings. Furthermore, and as described in subsequent paragraphs, the specific mechanical or electrical configurations described are intended to exemplify embodiments of the disclosure. However, alternative mechanical or electrical configurations are possible, which are considered to be within the teachings of the disclosure. Furthermore, unless otherwise indicated, “or” is to be considered inclusive.

Users of fiber only blankets have encountered a problem created by the weight of the blanket combined with gravitational effects of slight slope which combine to contribute to a loss of moisture to and from distal edges. This problem is also apparent in over-lapped edges as evidenced by concrete color changes near blanket edges at the overlap. This is in part caused by the nature of these fibers that favor moving moisture from higher to lower moisture areas until equalization is achieved. This invention solves this issue by taking advantage of this characteristic via the combination fiber only layer with a resin rich and fiber layer, wherein the addition of the resin and fiber allows from more available moisture to reduce the effect of moisture losses from the edges.

It was also discovered that this combination also creates an unexpected benefit and is the result of the resins ability to absorb excess moisture where it also substantially increases in size in the process, thus acting to beneficially increase the caliper of the blanket and therefore create even additional space for free water to reside than was originally available should the blanket have been constructed only of fibers. The stronger fibers, which could be OCC, also give the added benefit of helping to maintain stiffness, loft and free space for the curing water. Therefore, by taking advantage of proper layering and combination of the fibers and super absorbent resin a long standing issue of moisture loss around the edges of blankets is solved.

Employing a super absorbent resin in an absorbent layer of a curing blanket can resist the influence of gravity and retain the required moisture for a proper curing environment as described by ACI. This is especially important for sloped and vertical concrete elements that are often structural, like bridges and columns, and require maximum development of strength and durability from proper curing. The use of super absorbent resins also serves to conserve water in these applications thereby saving energy from transportation and pumping continuous large volumes and also further eliminating the constant drainage of high PH curing water that escapes from entering the local environment via runoff.

A complimentary effect is that the addition of one or more layers containing combinations of super absorbents, hydrophilic fibers and binders allows for the blanket to hold and make more water available for curing concrete than can be provided by a blanket having just hydrophilic fibers for absorption and space for free water to reside under the blanket. Moreover it is noted that the use of hydrophilic fibers in all non-barrier layers, i.e. vapor and moisture barriers, allows the for the wicking transport and free movement of the water between the layers to create the 100% humidity environment as cited in ACI to promote proper concrete curing.

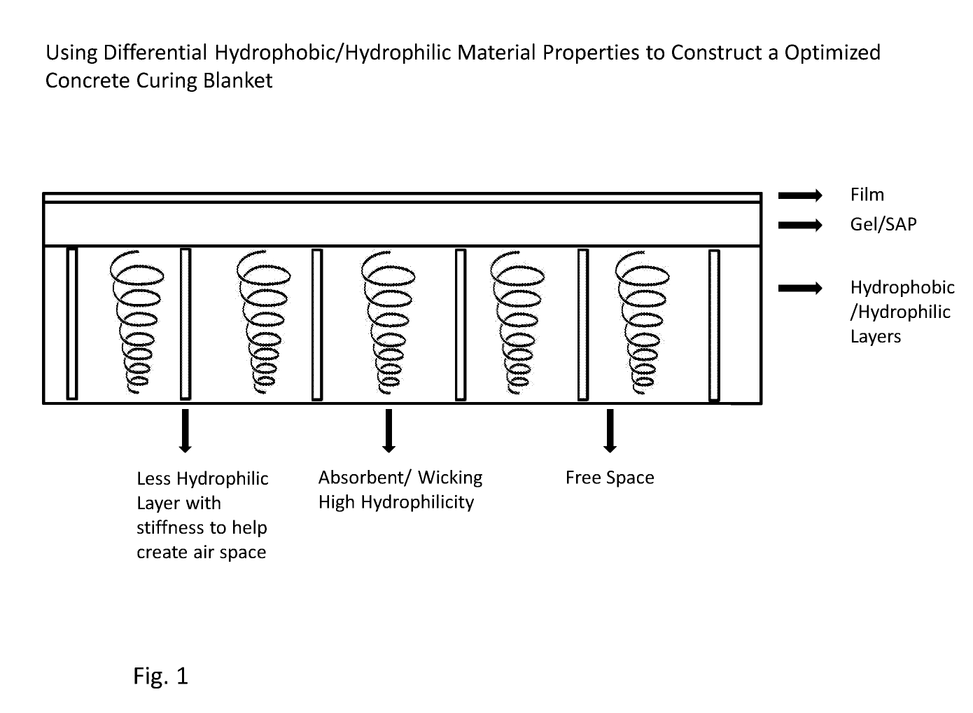

Referring to FIG. 1, another embodiment of a concrete curing blanket constructed according to principles of the invention includes a lower-most absorbent layer or free-space layer, an intermediate superabsorbent layer and an upper-most vapor barrier. Preferably, the lower-most layer, the water transport layer, is substantially free of superabsorbents and composed of hydrophillic fibers, which could be natural cellulose fibers, and the intermediate layer is the inverse: substantially free of natural cellulose fibers and composed substantially of superabsorbents. As with earlier embodiments that employ a layer with both superabsorbents and natural fibers, the superabsorbent-enhanced layer of this embodiment performs like a reservoir and the superabsorbent-free layer performs like a transport layer that wicks moisture from the superabsorbent-enhanced layer to portions of the superabsorbent-free layer that are dry, which would be attributable to the existence of localized relatively less hydrated area of the subjacent curing concrete.

Preferably, the lowermost layer incorporates a combination of hydrophillic and hydrophobic fibers that optimize water transport, yet maintain optimal loft. This layer should be a blend of no more than 75% hydrophobic fibers, excluding any recycled. Only the lignin remaining on the OCC fibers is hydrophobic. The fibers themselves are hydrophylic and stronger due to less chemical processing, which is why the lignin also remains. The exact blend will be determined by the coarseness and stiffness properties of the hydrophobic fibers in relation to the wicking properties of the hydrophylic fibers in the layer. So the range typically would be 25% hydrophylic to 75% hydrophobic, depending on the attributes of the fibers introduced into the matrix. However, the range could be up to 100% hydrophobic to 100% hydrophillic, or 100% natural fibers or 100% synthetic fibers, or 100% SAP, or 100% SAF as well depending on the application.

There are many types of hydrophilic fibers that can be put to use in a curing blanket, among those are market and/or fluff pulp, ground wood, rayon and cotton. These fibers need to be bleached such that they can no longer stain concrete by the release of tannins, lignin polysaccharides or other naturally occurring discolorants. Most of these fibers are widely used in the nonwoven industry today to achieve desired results in a wide range of products from personal hygiene to food liquid containment. It is this wide range of use combined with regulations in the industry that creates a large amount in-process manufacturing waste which cannot be reused due to the sensitive nature of the intended end use. This waste material also can contain super absorbent gels/powders/fibers and resins. Thus, the opportunity exists to use these materials by incorporating them into the layers of a concrete curing blanket nearest to the curing concrete, where the product is much less sensitive to manner of use, allowing large amount of useful material efficiency and benefit to be gained for industry and society.

Recycled fiber from post-consumer or pre-consumer fiber containing products like OCC, mixed office waste and certain fibers recovered from process sludges can be preferred materials for use in concrete curing blankets. The use of these materials in construction absorbents creates alternative use for recovered materials that has been limited to using virgin materials based on the sterile requirements of many absorbents and liquid transfer media. The lack of markets for non-sterile recovered fiber has required makers of construction absorbent to use virgin materials. Using these materials for a concrete curing blanket is possible and preferable if one gives considerations for absorbency.

Virgin fiber types used in these applications, especially the most common bleached fluff pulp, has an absorbency somewhere close to 10 grams/gram or greater. Recovered fiber from OCC typically has an absorbency of about 60% of fluff. Meaning that the curing blanket manufactured from recovered fiber may be viewed to require a higher fiber basis weight to achieve the same water carrying ability as compared to one manufactured from virgin fluff pulp. This would not be wholly accurate as, given two blankets, one of recovered fiber and the other of virgin fluff with identical calipers, both could hold the same amount of water if installed using the common flooded slab technique. This could be true because the space under the blanket for each material is the same due to the rule of equal caliper, meaning each could hold no more than its caliper (space under the blanket) will allow. However, since OCC is unbleached fiber and therefore has longer fibers, the recovered fiber blanket will require less basis weight to achieve bulk and caliper than a blanket manufactured from bleached fluff pulp. Since the act of bleaching reduces fiber length and strength. Which also means that a recovered fiber curing blanket has more advantage than just requiring less material, it also has an advantage less fiber under the blanket than a fluff pulp and therefore leaves more space to maximize free water under blanket.

The caveat to this is that curing blankets must be non-staining. OCC materials recovered for use today from once virgin materials have no extractables left to leach out due to original processes. These recovered materials are now widely marketed as raw materials and can be advantagous in cost over virgin materials by as much as $400 per ton depending on location and market conditions. Since today's construction industry favors and in most cases requires single use concrete curing blankets to avoid salt contamination and conserve water, using recovered rather than virgin fibers makes more sustainable sense.

These fibers can also be used in conjunction with super absorbent fibers, resins or liquids to solve problems for which today require vast amounts of water for flooding and constant spraying to achieve adequate curing. This combination can be tailored to create curing blankets for multiple applications ranging from the high curing water demands of mass concrete curing to vertical applications that require a much higher degree sequestration for resistance of moisture drainage from the blanket due to the effect of gravity.

Preferred embodiments of the invention are constructed as follows:

### Embodiment 1

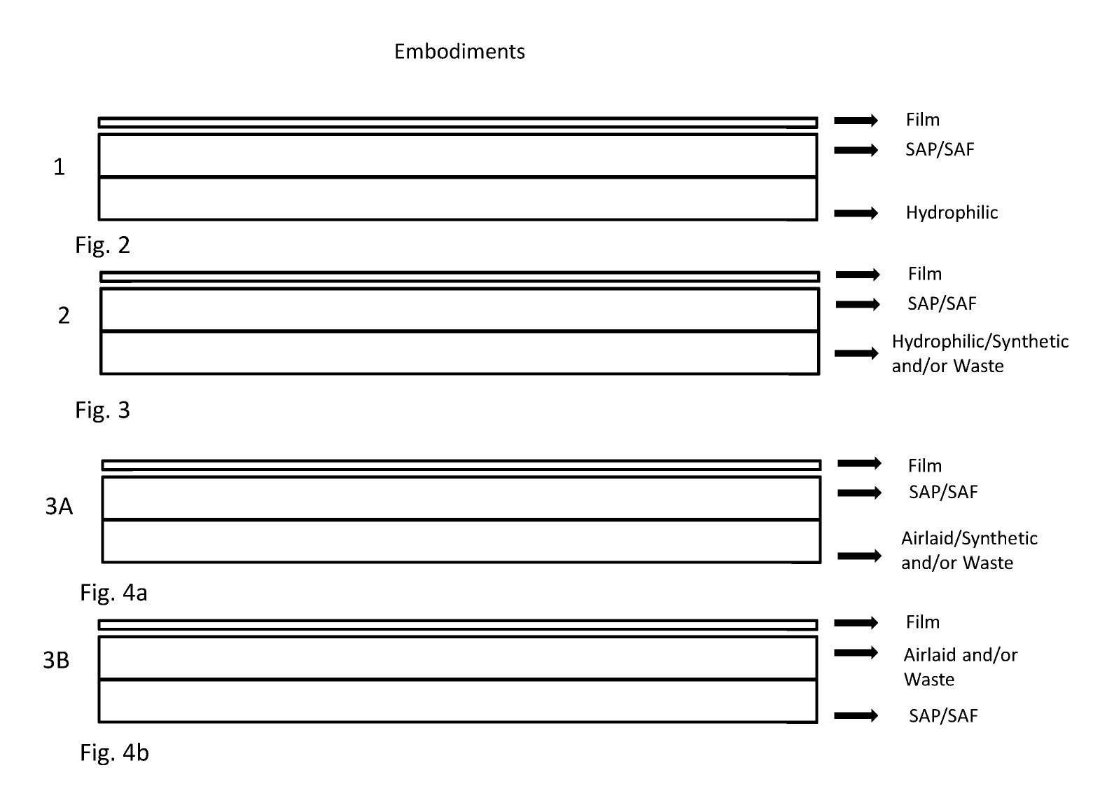

Referring to FIG. 2, an embodiment of a concrete curing blanket constructed according to principles of the invention includes a first layer of binder materials and hydrophilic fibers bonded to a second layer of binder materials, hydrophilic fibers and super moisture retaining resin bonded to a third layer comprising of a sheet having vapor barrier and lateral strength properties.

### Embodiment 2

Referring to FIG. 3, an embodiment of a concrete curing blanket constructed according to principles of the invention includes a first layer of binder materials, super absorbents and hydrophilic fibers bonded to a second layer comprising of a sheet having vapor barrier and lateral strength properties, wherein the first layer materials in part or wholly originate from in-process manufacturing waste of nonwoven products.

### Embodiment 3

Referring to FIGS. 3a and 3b, an embodiment of a concrete curing blanket constructed according to principles of the invention includes a first layer of binder materials and hydrophilic fibers bonded to a second layer of binder materials, hydrophilic fibers and super moisture retaining resin bonded to a third layer comprising of a sheet having vapor barrier and lateral strength properties, wherein the first layer and second layer materials in part or wholly originate from in-process manufacturing waste of nonwoven products.

### Embodiment 4

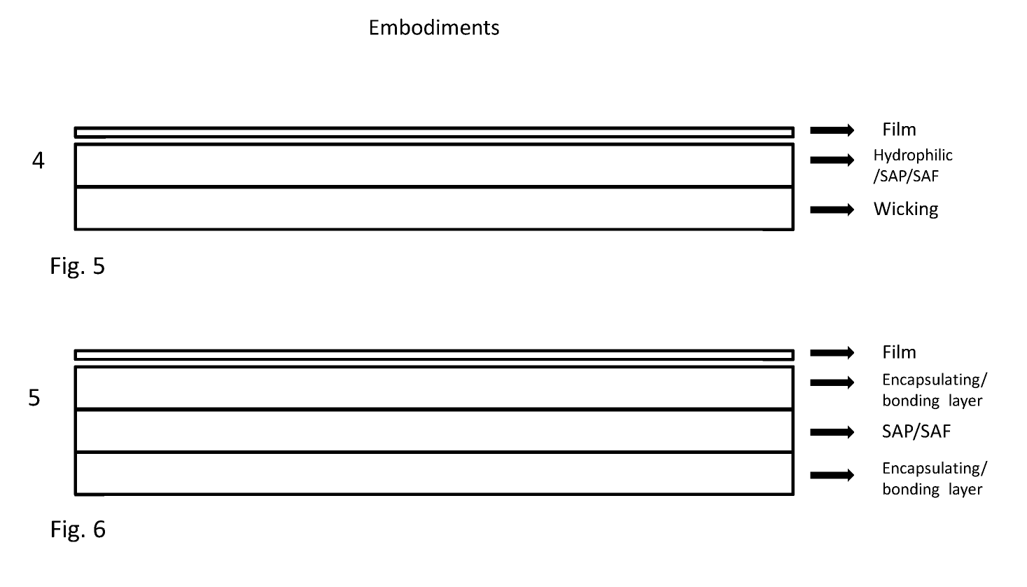

Referring to FIG. 5, an embodiment of a concrete curing blanket constructed according to principles of the invention includes a first layer of binder materials and hydrophilic fibers bonded to a second layer of binder materials, hydrophilic fibers and super moisture retaining resin bonded to a third layer comprising of a sheet having vapor barrier and lateral strength properties, wherein the wicking layer is operative to wick and retain moisture from oversaturated areas to dry areas to equalize moisture saturation within the wicking layer and apply substantially uniform wetness against a sloped or vertical surface of curing concrete.

### Embodiment 5

Referring to FIG. 6, an embodiment of a concrete curing blanket constructed according to principles of the invention includes a first layer of binder materials and hydrophilic fibers bonded to a second layer of super absorbent fibers or super absorbent polymer, bonded to a third layer of binder materials, and a forth layer comprising of a sheet having vapor barrier and lateral strength properties.

The invention is not limited to the particular embodiments described and depicted herein, rather only to the following claims.

We claim:

1. Concrete curing blanket comprising:
a film layer;
a differential hydrophobic/hydrophillic layer; and
a gel layer interposed between said film layer and said differential hydrophobic/hydrophillic layer.
